(19) United States
(12) Patent Application Publication
(10) Pub. No.: US 2007/0033539 A1
(43) Pub. Date: Feb. 8, 2007

(54) Displaying information

(76) Inventors: Jeffrey L. Thielman, Corvallis, OR (US); Mark E. Gorzynski, Corvallis, OR (US); Michael Blythe, Albany, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/197,719

(22) Filed: Aug. 4, 2005

(51) Int. Cl. G06F 3/00

(52) U.S. Cl. 715/769; 715/803; 715/814

(57) ABSTRACT

Embodiments of displaying information are disclosed.

### BACKGROUND

Interactive electronic projection systems allow human users to use a display surface as a mechanism both for viewing content, such as computer graphics, video, and the like, as well as for the input of information into the system. Such systems may limit image data input to a particular individual in a particular location.

### BRIEF DESCRIPTION OF THE DRAWINGS

FIG. 1 shows a schematic view of one embodiment of an interactive projection system.

FIG. 2 shows a schematic view of another embodiment of an interactive projection system.

FIG. 3 shows a schematic view of another embodiment of an interactive projection system.

FIG. 4 shows a schematic view of another embodiment of an interactive projection system.

FIG. 5 shows a schematic view of another embodiment of an interactive projection system.

FIG. 6 shows a schematic view of another embodiment of an interactive projection system.

### DETAILED DESCRIPTION

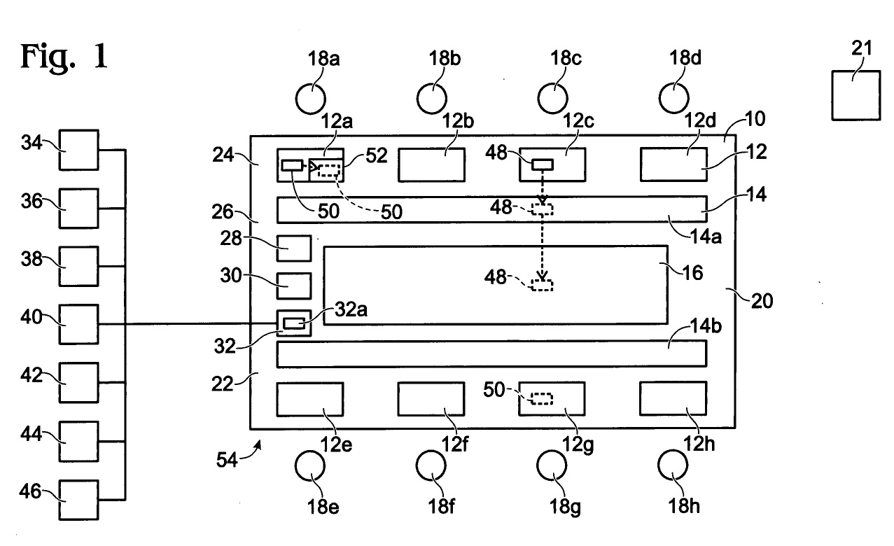

FIG. 1 shows a schematic view of one embodiment of an interactive projection system 10 including individual 12, semi-shared 14 and shared regions 16. System 10 may be a “social computer,” i.e., a computer that may be viewed by, and receive input, such as touch input, that is input provided using a touch sensitive screen, from, multiple operators 18 simultaneously. System 10 may include a table which may be sized to be used as an in-home coffee table (not shown) or as an office conference room table 20, for example. A top surface 22 of table 20 may define a substantially horizontal plane 24 and may function as a display surface 26. In other embodiments top surface 22 may be tilted from the horizontal or may be positioned vertically. Top surface 22 may be manufactured of glass or any other suitable material. Due to the relatively large size and horizontal orientation of display surface 26, the surface may be viewed by multiple users sitting or standing around table 22. In the embodiment shown, display surface 26 may be a touch sensitive screen and may allow input thereto by the multiple users 18a-18h sitting around the table.

Table 20 may further include one or more speaker/microphone systems 28 and one or more input devices 30, such as a floppy disk drive, a compact disk drive, a flash memory drive, or the like. Accordingly, system 10 may receive input or output via display surface 26, microphone 28 and/or input device 30. System 10 may include a controller 32 that may be connected to and may be utilized to control fixtures in a room in which the system is housed, for example, a lighting system 34, a wall-mounted projection screen 36, that may display, for example, the contents of any of region 12, 14 or 16, a heating system 38, an air conditioning system 40, a facsimile machine 42, a copying machine or printer 44, and a window covering system 46, such as vertical blinds, curtains, or self-darkening windows, all shown schematically. Accordingly, system 10 may be utilized, via touch input, to control the environment of a room in which table 20 is situated. In another embodiment, system 10 may allow one table 20 to control another table 21 situated adjacent the first table 20, or situated at another site, remote from the first table 20.

In the embodiment shown table 20 is substantially rectangular in shape. In other embodiments, table 20 may be any suitable shape as is desired for a particular application or room shape, such as an oval, a semicircle, a parallelogram, or an abstract shape.

Still referring to FIG. 1, individual operators or users 18 of the system may be indicated by numbers 18a through 18h. Each of individual operators 18a-18h shown may be associated with their own individual region 12a-12h for input and manipulation of data therein. In other words, each of individual regions 12a-12h may be accessible by the individual seated at the particular individual location and not by other individuals seated at other locations. In a conference setting, the individual operator 18 may utilize their individual region 12 to bring up their own data files, to create their own notes of a conference taking place at the table, and to sketch their own drawings or ideas. This data may be visible on their corresponding individual region 12 and not on other individual regions. For example, screen 12d may be visible to and manipulated by operator 18d. Some or all of individual operators 18 may be physically present at table 20, or some or all of operators 18 may be at sites 21 remote from table 20. Accordingly, some of the touch enabled devices and/or display devices of the system may be positioned at table 20 or at a site 21 remote from table 20. In such an embodiment, remote site 21 may include or allow access to a shared region 16.

Semi shared region 14 may include two or more such semi-shared regions 14a and 14b, wherein two or more individual regions, such as regions 12a-12d, may be associated with semi-shared region 14a and individual regions 12e-12h may be associated with semi-shared region 14b. Each or some of semi-shared regions 14 may be a single view region that several operators 18 view together, or may be a replication of data positioned in front of each individual operator 18, at a single or at multiple locations. Accordingly, each of individuals 12a-12d may use touch enabled display 26 to cause a change in a location of the display of data between their individual region 12 and semi-shared region 14. For example, operator 18c may cause movement of an embodiment of an object, such as displayed icon 48 corresponding to a file, from their individual region 12c to semi-shared region 14a by placing their finger on icon 48, and then dragging the icon 48 with their finger across touch enabled display 26 to semi-shared region 14a. Once icon 48 is positioned within semi-shared region 14a, each of individuals 18a-18d may view and manipulate icon 48 in semi-shared region 14a. However, individuals 18e-18h may not be able to view or manipulate icon 48 while it is positioned within semi-shared region 14a. Any of operators 18a-18d may then drag icon 48 from their semi-shared region 14a to shared region 16 by placing their finger on icon 48 and then dragging the icon 48 with their finger across touch enabled display 26 to shared region 16. Once icon 48 is positioned within shared region 16, each of individuals 18a-18h may view and manipulate icon 48 in shared region 16. For example, when icon 48 is in shared region 16, individual operator 18h may drag icon 48 into their individual region 12h. Moreover, when icon 48 is in shared region 16, operators at remote site 21 may be able to access icon 48.

In another embodiment, the object may comprise a physical object such as a token that may be dragged across touch enabled display 26 from individual region 12 to shared region 16 as a way to provide input. The token may include a communication device, such as a wire, an RF device, an IR device, an optical device, or the like, so as to communicate with system 10 through top surface 22.

Still referring to FIG. 1, an individual operator 18a, for example, may drag an embodiment of an object, such as icon 50 corresponding to a file, contained within their individual region 12a to individual region 12g, such that operator 18g may view the file corresponding to icon 50, but other individual operators around table 20 may not be able to view the file corresponding to icon 50. In another embodiment, individual region 12a may allow touch input by operator 18a which may allow moving of icon 50 to a transport region 52 positioned within region 12a such that operator 18a does not reach across table 20 to deliver the icon 50 to individual region 12g. Such a transport region 52 within each of the individual regions 12 may facilitate a discrete transfer of the ability to access files throughout system 10. An individual region 12 may also display commands to an operator 18 such that the operator may choose, via touch input within their individual region 12, to copy a icon 50, for example, to different individual regions 12 or to cause movement of the original icon 50 to another individual region 12. Controller 32 may also allow an individual operator to choose, via touch input within their individual region 12, whether the file corresponding to transferred icon 50 will be a read only file, a data manipulatable file, or the like.

Accordingly, the display location of information may be changed from a first location in one of said individual regions, said semi-shared regions and said shared region to a second, different location in one of said individual regions, said semi-shared regions and said shared region. Controller 32 may include software 32a (see FIG. 1) for regulating the change in display location of information within the system.

In one embodiment, controller 32 may include software such that when icon 48 is moved from shared region 16 to a semi-shared region 14 or to an individual region 12, the icon 48 will be copied to that region but the original icon 48 will remain in shared region 16. In such an embodiment, icon 48 within shared region 16 may have to be deleted to be removed from shared region 16. In another embodiment, controller 32 may include software such that when an icon 48 is moved from shared region 16 to a semi-shared region 14 or to an individual region 12, the icon 48 will be moved to the semi-shared or individual region and will not remain in shared region 16, i.e., the original icon, and not a copy of the icon 48, is moved. In the embodiment shown, shared region 16 is shown as one display region. In another embodiment, shared region 16 may comprise a plurality of replicated display regions.

Accordingly, system 10 may be utilized during a business conference to display and share information, to collectively collaborate or “brainstorm” a particular subject, to collectively edit a document, or to assign tasks to individuals. Controller 32 allows individual operators to transfer data throughout the system and to control the particular form of the transferred data. System 10 may also be utilized, for example, to play a social game, such as a computerized card game involving teams. Still other uses of system 10 may include stock trading, auctions, interviews, and the like.

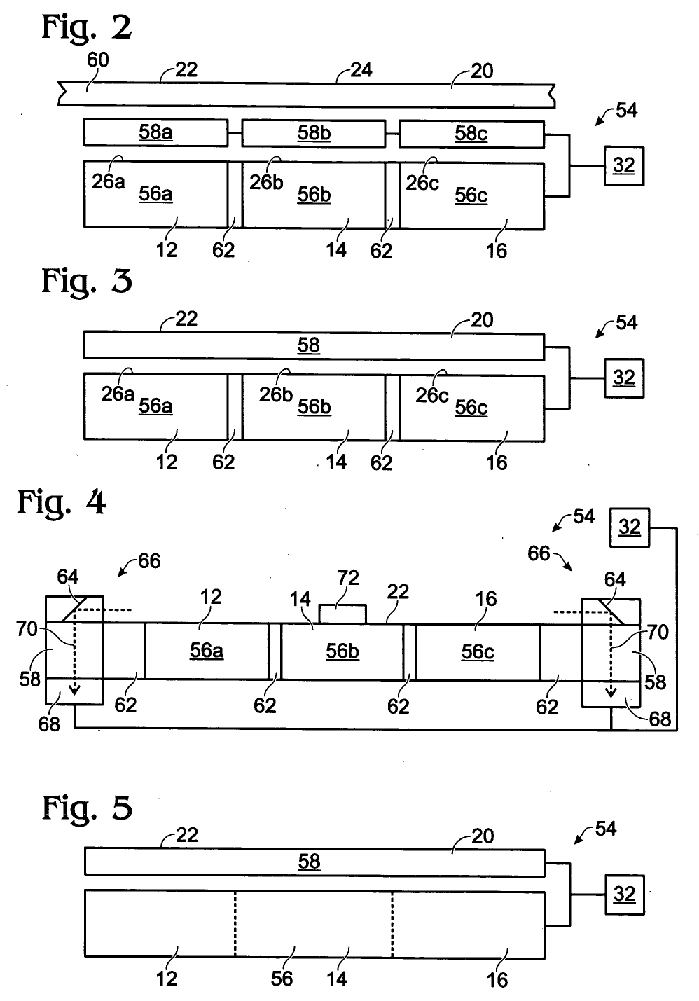

FIG. 2 shows a schematic view of one embodiment of an interactive projection system 10 including an individual region 12, a semi-shared region 14, and a shared region 16, positioned within an individual location 54. Each of regions 12, 14 and 16 may define a separate display surface 26a, 26b and 26c, respectively, of a respective optical display device 56a, 56b and 56c. Optical display devices 56a, 56b and 56c may be any suitable display device, such as an optical modulator, a liquid crystal display, a PDP or a projection screen, or the like, and may be connected to controller 32. Each of regions 12, 14 and 16 may include a separate touch enabled device 58a, 58b and 58c, associated with each of display surfaces 26a-26c, and may be a resistive device, a capacitive device, an optical device, or the like, as will be understood by those skilled in the art. In such an embodiment, wherein touch enabled devices 58a-58c are positioned on top of display surfaces 26, the touch enabled devices may be referred to as an overlay. A transparent, protective surface, such as a glass plate 60, may be positioned over touch enabled devices 58 and may define top surface 22 of table 20. In another embodiment, the touch surface may also function as the display surface.

In such an embodiment including separate optical display devices 56a-56c, a bezel 62 may be positioned and provide a substantially smooth transition between each of devices 56a-56c. The touch enabled devices 58 may each be connected to controller 32 which may coordinate the multiple touch enabled devices. Accordingly, when a finger (or a physical object, such as a game token) is dragged by an operator across a boundary between adjacent touch enabled devices, controller 32 will recognize the continuing path across the multiple devices 58a-58c.

FIG. 3 shows a schematic view of one embodiment of an interactive projection system 10 including an individual region 12, a semi-shared region 14, and a shared region 16, positioned within an individual location 54. Each of regions 12, 14 and 16 may define a separate display surface 26a, 26b and 26c, respectively, of a respective optical display device 56a, 56b and 56c. Optical display devices 56a, 56b and 56c may be any suitable presently developed or future developed display device, such as an optical modulator, a liquid crystal display, or the like, and may be connected to controller 32. Each of regions 12, 14 and 16 may be positioned below a single touch enabled device 58, which may be a resistive device, a capacitive device, an optical device, or the like. In such an embodiment, touch enabled device 58 may extend across table 20 and may define top surface 22 of table 20.

In such an embodiment including separate optical display devices 56a-56c, a bezel 62 may be positioned between each of optical display devices 56. Single touch enabled device 58 may be a SMART optical device, a Next Window optical device, or a 3M Near Field Optical Imaging device, or the like. The touch enabled device 58 may be connected to controller 32 which may coordinate touch enabled input to the touch enabled device 58.

FIG. 4 shows a schematic view of one embodiment of an interactive projection system 10 including individual region 12, a semi-shared region 14, and a shared region 16, wherein an individual location 54 is shown having a single touch enabled display system 58 positioned in an edge region 66 of the display surface. In this embodiment, touch enabled display system 58 may include a plurality of optical components 64, such as mirrors, prisms and/or lenses, positioned in multiple positions around edge region 66 of top surface 22 of the display surface, wherein each optical component may be associated with a camera 68. Each of optical components 64 may reflect an image 70 of an object 72 (such as an operator's finger or a token) on top surface 22 to camera 68 as the object 72 is moved across top surface 22. Controller 32 may coordinate the images received by multiple cameras 68 and may utilize triangulation algorithms or the like to track the path of object 72 as it is moved across top surface 22 of table 20. In this embodiment, wherein optical components 64 of touched enabled device 58 protrude above optical display device 56, the optical components may be referred to as an overlay.

FIG. 5 shows a schematic view of one embodiment of an interactive projection system 10 including an individual region 12, a semi-shared region 14 and a shared region 16 within a single display device 56. A single touch enabled device 58 may be positioned above display device 56, wherein device 56 and device 58 may each be connected to controller 32. Single display device 56 may be any suitable display device, such as an optical modulator, a liquid crystal display, or the like. Single touch enabled device 58 may be a SMART optical device, a Next Window optical device, or a 3M (Registered Trademark) Near Field Optical Imaging device, or the like. In this embodiment controller 32 may recognize region 12 of single display 56 as an individual region, and may recognize regions 14 and 16, respectively, as semi-shared and shared regions. This embodiment may be better suited in some applications over multiple display embodiments in that there may be no gap or bezel utilized between the different regions. However, in this single display embodiment, single display 56 may have a size greater than the individual displays 56 of other embodiments and, therefore, may be manufactured with a lower resolution than smaller individual displays 56 of other embodiments.

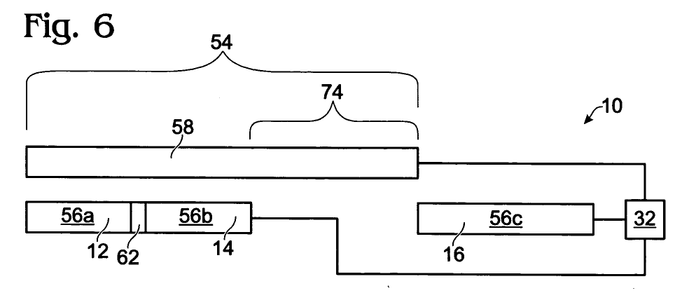

FIG. 6 shows a schematic view of one embodiment of an interactive projection system 10 including an individual region 12, a semi-shared region 14 and a shared region 16, wherein shared display region 16 is positioned outside individual location 54 and outside of a region covered by a single touch enabled device 58. Single touch enabled device 58 may be positioned above display devices 56a and 56b, and may cover a virtual shared region 74. Accordingly, an operator may input instructions or may manipulate data via touch input within region 74, wherein the input instructions and manipulations will be visible on display device 56c within shared region 16. In particular, devices 56 and device 58 may each be connected to controller 32. An operator may manipulate input in shared region 16 by touching virtual shared region 74 positioned within individual location 54.

Shared region 16 and display device 56c may be positioned horizontally as shown, or may be positioned vertically, such as a wall mounted projection screen, viewable by all operators within a conference room, for example. Single display devices 56a-56c may be any suitable display device, such as an optical modulator, a liquid crystal display, or the like. Single touch enabled device 58 may be a SMART optical device, a Next Window optical device, or a 3M Near Field Optical Imaging device, or the like. In this embodiment controller 32 may recognize region 12 of single display 56 as an individual region, and may recognize regions 14 and 16, respectively, as semi-shared and shared regions. However, input to shared region 16 may be accomplished within virtual shared region 74 of individual region 54, whereas input displayed by shared region 16 may be displayed in display region 56c positioned outside individual region 54. This embodiment may have an advantage over other embodiments in that the shared display region 16 may be easily visible on a large scale, such as on a projection screen.

Other variations and modifications of the concepts described herein may be utilized and fall within the scope of the claims below.

What is claimed is:

1. A system for displaying information, comprising:
a first screen region adapted to receive first input from multiple operators;
a second screen region adapted to receive second input from a single operator during a time interval; and
a controller operable to control display of the information and to transfer the display of the information between, said first screen region and said second screen region according to the first input or the second input.

2. The system of claim 1 further comprising a third screen region adapted to receive third input from a second single operator during a second time interval.

3. The system of claim 2 wherein said controller includes a configuration to transfer display of the information between, said first, second and third screen regions.

4. The system of claim 1 further comprising a third screen region adapted to receive input from only a sub-set of said multiple operators.

5. The system of claim 4 wherein said third screen regions is operably coupled to said controller and wherein said controller controls display of the information, and transfer of the display of the information between, said first, second and third screen regions.

6. The system of claim 2 wherein said first, second and third screen regions are touch sensitive, wherein said first input, second input, and third input include, respectively, first touch input, second touch input, and third touch input, and wherein said controller is configured to detect said first touch input, said second touch input, and said third touch input and to manipulate the information based on said first touch input, said second touch input, and said third touch input.

7. The system of claim 6 wherein said controller is configured to display the information on said first screen region based on said second touch input received in said second screen region.

8. The system of claim 1 wherein said first screen region is adapted to receive touch input to control a fixture positioned external to said system.

9. The system of claim 1 wherein the information is displayed in said second screen region by said controller responsive to said first input from said first screen region.

10. The system of claim 1 wherein said first screen region and said second screen region each include a configuration to detect touch input with the configuration including one chosen from detecting resistively, capacitively, and optically.

11. The system of claim 1 wherein said first screen region and said second screen region are touch enabled and each comprise one of a liquid crystal display, a PDP and a projection screen, wherein a first display comprises said first screen region and a second display comprises said second screen region and wherein said system further comprises one of a single touch enabled overlay that extends over each of said first display and said second display and a single touch enabled device that extends below each of said first display and said second display.

12. The system of claim 11 wherein said touch enabled device comprises a plurality of cameras positioned below said first and second displays.

13. The system of claim 1 wherein a single display comprises said first screen region and said second screen region.

14. The system of claim 1 wherein said second screen region is positioned on a substantially horizontal table top and wherein said first screen region is positioned on a substantially vertical projection display.

15. The system of claim 1 wherein said first screen region is positioned on a substantially horizontal table top and extends substantially across an entire surface area of said table top, and wherein an entirety of said first screen region is touch enabled.

16. A display system, comprising:
a touch enabled display surface including,
an individual area configured to receive first input from a single user, and
a shared area adapted for receiving second input from multiple users; and
a controller operably coupled to said individual area and to said shared area and controlling display of data on said individual and shared areas based on the first input or the second input to said individual or said shared areas.

17. The system of claim 16 wherein said touch enabled display surface includes an input detection system positioned between said individual and shared areas and said users.

18. The system of claim 16 wherein said touch enabled display surface includes an input detection system positioned opposite said individual and shared areas from said users.

19. The system of claim 18 wherein said input detection system comprises a plurality of cameras positioned to detect an object on said display surface.

20. The system of claim 18 further comprising a second individual area configured to receive input from a second single user, wherein said controller is operably coupled to said second individual area and controls display of data on said individual, said second individual and said shared areas based on instructions input to any of said individual, said second individual and said shared areas, wherein said second individual area is positioned remote from said individual and said shared areas.

21. A method, comprising:
projecting an image onto a surface, the image visible on the surface, said image defining a shared portion and an individual portion; and
manipulating the shared portion of said image by ones of multiple operators and manipulating the individual portion of said image by an individual one of said multiple operators.

22. The method of claim 21 wherein said image includes a plurality of individual portions, each of said plurality of individual portions touch enabled by a corresponding individual operator, wherein an individual operator may cause movement of display of information from their corresponding individual portion of said image to said shared portion of said image.

23. The method of claim 21 wherein said manipulating said shared portion of said image comprises touch-enabled manipulating.

24. A multi-operator computer, comprising:
means for projecting an image to a display surface;
means for receiving touch-enabled input on said display surface from multiple operators; and
means for distinguishing said touch-enabled input from each of individual ones of said multiple operators and for controlling said image projected to said display surface based on said touch-enabled input from individual ones of said multiple operators.

25. The computer of claim 24 wherein said means for receiving touch-enabled input defines a shared region for input from said multiple operators, and defines a plurality of individual regions each adapted for receiving touch-enabled input from said each individual ones of said multiple operators.

26. The computer of claim 24 wherein said means for receiving is a touch sensitive surface positioned on said display surface.

27. The computer of claim 24 wherein said means for receiving is chosen from one of a camera system positioned below said display surface and a touch sensitive surface.

28. A computer readable medium, comprising:
code to display a shared region to receive input from multiple operators;
code to display an individual region to receive input from an individual operator;
code to manipulate displayed first data in said shared region based on first input by said individual operator in said individual region; and
code to manipulate displayed second data in said individual region based on second input by said individual operator in said individual region.

29. The medium of claim 28 further comprising code to provide an image in said shared region, and wherein said image is changed based on manipulation of said displayed first data in said shared region based on said first input by said individual operator in said individual region.

30. The medium of claim 28 further comprising code to provide an image in said individual region, and wherein said image is changed based on manipulation of said displayed second data in said individual region based on said second input by said individual operator in said individual region.
